(19) United States
(12) Patent Application Publication
(10) Pub. No.: US 2026/0261161 A1
(43) Pub. Date: Sep. 3, 2026

(54) CYLINDRICAL MEMBER, TAPERED PART-ATTACHED CYLINDRICAL MEMBER, SURFACE MAGNET MOTOR, AND METHOD FOR PRODUCING SURFACE MAGNET MOTOR

(71) Applicant: MITSUBISHI ELECTRIC CORPORATION, Tokyo (JP)

(72) Inventors: Ichiya TAKAHASHI, Tokyo (JP); Kazunori TAKAGAKI, Tokyo (JP); Tatsuya KOYAMA, Tokyo (JP); Hiroki KOBAYASHI, Tokyo (JP); Masami KUME, Tokyo (JP)

(73) Assignee: MITSUBISHI ELECTRIC CORPORATION, Tokyo (JP)

(21) Appl. No.: 19/489,921

(22) PCT Filed: Mar. 18, 2024
(86) PCT No.: PCT/JP2024/010553

§ 371 Date: Dec. 4, 2025

(30) Foreign Application Priority Data
Jul. 6, 2023 (WO) PCT/JP2023/025177

(51) Int. Cl. H02K 1/04; H02K 1/278; H02K 1/28; H02K 15/028

(52) U.S. Cl. CPC H02K 1/04; H02K 1/278; H02K 1/28; H02K 15/028; H02K 2213/03

(57) ABSTRACT

A cylindrical member is formed of a fiber reinforced plastic having a relationship expressed by Formula 2 when a stress-strain relational equation in an XY-plane is expressed as shown by Formula 1 in an orthogonal coordinate system O-XYZ, where an origin O is a midpoint in a thickness direction, of a small-sized element of the cylindrical member, an X-axis is along a tangent direction of a cylinder, a Y-axis is along a direction parallel to an axial direction of the cylinder, a Z-axis is along a radial direction of the cylinder, σ is a stress vector, ε is a strain vector, τ is shear stress, γ is shear strain, and an element Qᵢⱼ is an i-th row, j-th column element of an in-plane rigidity matrix Q.

$$Formula 1$$

$$\{ \begin{matrix}{σ}_{x} \\ {σ}_{y} \\ {τ}_{xy}\end{matrix} \} ≡ \{ σ \} = [ \begin{matrix}{Q}_{11} & {Q}_{12} & {Q}_{16} \\ {Q}_{12} & {Q}_{22} & {Q}_{26} \\ {Q}_{16} & {Q}_{26} & {Q}_{66}\end{matrix} ] \{ \begin{matrix}{ε}_{x} \\ {ε}_{y} \\ {γ}_{xy}\end{matrix} \} ≡ [ Q ] \{ ε \}$$

$$Formula 2$$

$${Q}_{12} {Q}_{26} - {Q}_{16} {Q}_{22} \neq 0$$

### FIELD

The present disclosure relates to a cylindrical member formed of a fiber reinforced plastic, a tapered part-attached cylindrical member, a surface magnet motor using a cylindrical member, and a method for producing a surface magnet motor.

### BACKGROUND

A cylindrical member formed of a fiber reinforced plastic (FRP) is conventionally known. For example, Patent Literature 1 discloses a rotor using a rotor body unit having a cylindrical shape, formed of a fiber reinforced plastic. The rotor is configured such that a hub, serving as a core unit, is press fit into an inner diameter side of the rotor body unit with a tightening margin. The rotor generates tension along a circumferential direction of the rotor body unit to generate frictional force on a contact surface between the rotor body unit and the hub. This prevents slippage of the rotor body unit against the hub when the rotor rotates.

### CITATION LIST

### Patent Literature

Patent Literature 1: Japanese Patent Application Laid-open No. 2002-95208

### SUMMARY OF INVENTION

### Problem to be Solved by the Invention

However, press fitting of the hub into the inner diameter side of the rotor body unit with a tightening margin as done for the rotor of Patent Literature 1 requires a large press fitting force and thus requires large-scale and complex equipment for generating such press fitting force.

The present disclosure has been made in view of the foregoing, and it is an object of the present disclosure to provide a cylindrical member that enables reduction in press fitting force for a core unit to be press fit into the inner diameter side of a cylindrical member.

### Means to Solve the Problem

In order to solve the above-described problems and achieve the object, a cylindrical member according to the present disclosure is formed of a fiber reinforced plastic having a relationship expressed by Formula 2 when a stress-strain relational equation in an XY-plane is expressed as shown by Formula 1 in an orthogonal coordinate system O-XYZ, in which an origin O is a midpoint in a thickness direction, of a small-sized element of the cylindrical member, an X-axis is along a tangent direction of a cylinder, a Y-axis is along a direction parallel to an axial direction of the cylinder, a Z-axis is along a radial direction of the cylinder, σ is a stress vector, ε is a strain vector, τ is shear stress, γ is shear strain, and an element Qᵢⱼ is an i-th row, j-th column element of an in-plane rigidity matrix Q.

$$\{ \begin{matrix}\begin{matrix}{σ}_{x} \\ {σ}_{y}\end{matrix} \\ {τ}_{xy}\end{matrix} \} ≡ \{ σ \} = [ \begin{matrix}{Q}_{11} & {Q}_{12} & {Q}_{16} \\ {Q}_{12} & {Q}_{22} & {Q}_{26} \\ {Q}_{16} & {Q}_{26} & {Q}_{66}\end{matrix} ] \{ \begin{matrix}\begin{matrix}{ε}_{x} \\ {ε}_{y}\end{matrix} \\ {γ}_{xy}\end{matrix} \} ≡ [ Q ] \{ ε \} \qquad Formula 1$$

$${Q}_{12} {Q}_{26} - {Q}_{16} {Q}_{22} \neq 0 \qquad Formula 2$$

### Effects of the Invention

A cylindrical member according to the present disclosure provides an advantageous effect in enabling reduction in press fitting force for a core unit to be press fit into the inner diameter side of a cylindrical member.

### BRIEF DESCRIPTION OF DRAWINGS

FIG. 1 is a perspective view illustrating a cylindrical member according to a first embodiment.

FIG. 2 is a perspective view illustrating a surface magnet motor including the cylindrical member according to the first embodiment.

FIG. 3 is a front view of the surface magnet motor including the cylindrical member according to the first embodiment, as viewed from an axial direction.

FIG. 4 is an illustrative diagram illustrating a method for producing the surface magnet motor including the cylindrical member according to the first embodiment.

FIG. 5 is an illustrative diagram illustrating a method for producing multiple surface magnet motors including the cylindrical member according to the first embodiment.

FIG. 6 is a perspective view illustrating a cylindrical member according to a second embodiment.

FIG. 7 is a plan view of the cylindrical member according to the second embodiment, as viewed from the cylindrical axial direction.

FIG. 8 is an enlarged view of portion VIII illustrated in FIG. 7.

FIG. 9 is a perspective view illustrating a specific example of the cylindrical member according to the second embodiment.

FIG. 10 is an enlarged view of portion X illustrated in FIG. 9, illustrated with virtual cut planes.

FIG. 11 is an illustrative diagram schematically illustrating an example of method for producing the cylindrical member according to the second embodiment.

FIG. 12 is a perspective view illustrating a method for evaluating a “torsion-expansion characteristic” of the cylindrical member according to the second embodiment.

FIG. 13 is a transverse cross-sectional view illustrating the method for evaluating the “torsion-expansion characteristic” of the cylindrical member according to the second embodiment.

FIG. 14 is an illustrative diagram illustrating a method for producing the surface magnet motor using a tapered part-attached cylindrical member according to a third embodiment.

FIG. 15 is a cross-sectional view of part of the tapered part-attached cylindrical member according to the third embodiment, taken along the cylindrical axial direction.

FIG. 16 is an illustrative diagram illustrating a method for producing multiple surface magnet motors using the tapered part-attached cylindrical member according to the third embodiment.

### DESCRIPTION OF EMBODIMENTS

A cylindrical member, a tapered part-attached cylindrical member, a surface magnet motor, and a method for producing the surface magnet motor according to embodiments of the present disclosure will be described in detail below with reference to the drawings.

### First Embodiment

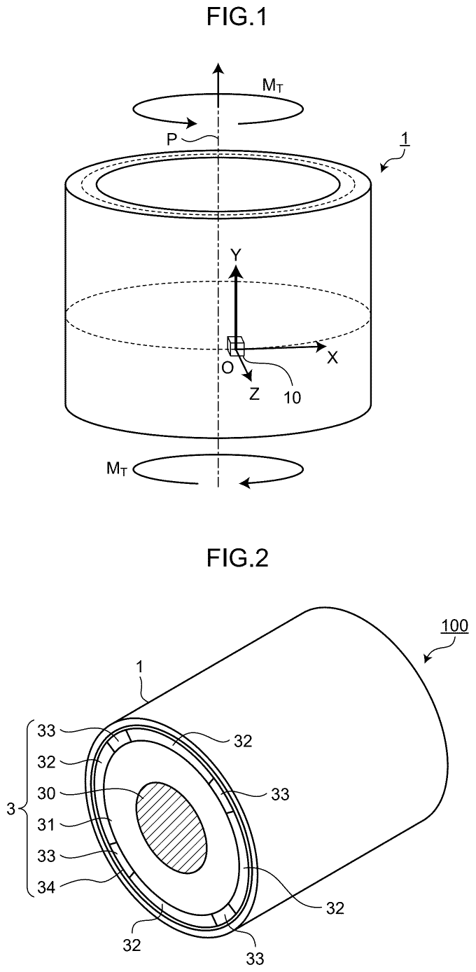

FIG. 1 is a perspective view illustrating a cylindrical member according to a first embodiment. To denote a direction for defining features of a cylindrical member 1, which is a material direction, an orthogonal coordinate system O-XYZ is defined in FIG. 1. The orthogonal coordinate system O-XYZ is a coordinate system in which, assuming a small-sized element 10 of the cylindrical member 1, the origin O is the midpoint in the thickness direction, of the small-sized element 10, an X-axis is along a tangent direction of the cylinder, a Y-axis is along a direction parallel to an axial direction P of the cylinder, and a Z-axis is along a radial direction of the cylinder. In addition, the direction of a torsional moment M_{T} exerted on the cylindrical member 1 is defined such that a right-hand screw direction around the cylindrical axis is the positive direction.

The cylindrical member 1 is formed of a fiber reinforced plastic, which includes a reinforcement fiber solidified with a resin. The reinforcement fiber can be, for example, a carbon fiber or a glass fiber, as well as an organic fiber such as a para-aramid fiber or a polyester fiber. The resin can be a thermosetting resin such as an epoxy resin, an unsaturated polyester resin, or an epoxy acrylate resin, or a thermoplastic resin such as polyamide, polypropylene, polyethylene, polystyrene, polyethylene terephthalate, polycarbonate, polyetheretherketone, or polyphenylene sulfide. The fiber can be, in terms of the form thereof, a continuous fiber or a discontinuous fiber such as one produced by injection molding or compression molding. The cylindrical member 1 is formed of an anisotropic material in the orthogonal coordinate system O-XYZ. According to Reference Literature 1 (Japan Society of Mechanical Engineers, “Kikai Kogaku Binran DVD-ROM-ban α3-hen Zairyo Kogaku” (English equivalent: JSME Mechanical Engineers' Handbook, DVD-ROM version, vol. α3, Mechanics of Materials) (first edition), Maruzen (2014). Section 12.4, pp. 160-163), the stress-strain relational equation in the XY-plane can be expressed by Equation (1.1).

$$\begin{matrix}Formula 3 & \\ \{ \begin{matrix}\begin{matrix}{σ}_{x} \\ {σ}_{y}\end{matrix} \\ {τ}_{xy}\end{matrix} \} ≡ \{ σ \} = [ \begin{matrix}{Q}_{11} & {Q}_{12} & {Q}_{16} \\ {Q}_{12} & {Q}_{22} & {Q}_{26} \\ {Q}_{16} & {Q}_{26} & {Q}_{66}\end{matrix} ] \{ \begin{matrix}\begin{matrix}{ε}_{x} \\ {ε}_{y}\end{matrix} \\ {γ}_{xy}\end{matrix} \} ≡ [ Q ] \{ ε \} & ( 1.1 )\end{matrix}$$

In Equation (1.1), {σ} is a stress vector in the XY plane, {ε} is a strain vector in the XY plane, and [Q] is an in-plane rigidity matrix. Elements in the third row and in the third column in Equation (1.1) have subscripts including a number of 6 instead of a number of 3. This is because, as indicated in Reference Literature 1, a three-dimensional stress-strain relational equation has been reduced to a two-dimensional one. A similar notation is also used in equations set forth below. Solving Equation (1.1) for {ε} provides Equation (1.2), and εₓ can thus be expressed by Equation (1.3).

$$\begin{matrix}Formula 4 & \\ \{ \begin{matrix}\begin{matrix}{ε}_{x} \\ {ε}_{y}\end{matrix} \\ {γ}_{xy}\end{matrix} \} = {[ Q ]}^{- 1} \{ \begin{matrix}\begin{matrix}{σ}_{x} \\ {σ}_{y}\end{matrix} \\ {τ}_{xy}\end{matrix} \} & ( 1.2 )\end{matrix}$$

$$\begin{matrix}Formula 5 & \\ {ε}_{x} = {[ Q ]}_{11}^{- 1} \cdot {σ}_{x} + {[ Q ]}_{12}^{- 1} \cdot {σ}_{y} + {[ Q ]}_{16}^{- 1} \cdot {τ}_{xy} & ( 1.3 )\end{matrix}$$

In Equation (1.3), [Q]ᵢⱼ⁻¹ is an ij-th element of the inverse matrix of the matrix [Q]. Assuming that there is only shear stress τ_{xy} caused by torsion (i.e., σₓ=σ_{y}=0), Equation (1.4) is obtained.

$$\begin{matrix}Formula 6 & \\ {ε}_{x} = {[ Q ]}_{16}^{- 1} \cdot {τ}_{xy} & ( 1.4 )\end{matrix}$$

In this respect, the element [Q]₁₆⁻¹ is specifically described as Equation (1.5).

$$\begin{matrix}Formula 7 & \\ {[ Q ]}_{16}^{- 1} = \frac{1}{detQ} ( {Q}_{12} {Q}_{26} - {Q}_{16} {Q}_{22} ) & ( 1.5 )\end{matrix}$$

The symbol detQ represents the determinant of the matrix [Q] and is expressed by Equation (1.6).

$$\begin{matrix}Formula 8 & \\ detQ = {Q}_{11} {Q}_{22} {Q}_{66} + {Q}_{12} {Q}_{26} {Q}_{16} + {Q}_{16} {Q}_{12} {Q}_{26} - {Q}_{11} {Q}_{26} {Q}_{66} - {Q}_{12} {Q}_{12} {Q}_{66} - {Q}_{16} {Q}_{22} {Q}_{16} & ( 1.6 )\end{matrix}$$

In this respect, the cylindrical member 1 according to the present first embodiment is characterized in satisfying Equation (1.7).

$$\begin{matrix}Formula 9 & \\ {Q}_{12} {Q}_{26} - {Q}_{16} {Q}_{22} \neq 0 & ( 1.7 )\end{matrix}$$

By satisfying Equation (1.7), the cylindrical member 1 has the following feature. That is, exertion of the torsional moment M_{T} on the cylindrical member 1 causes the shear stress τ_{xy} to occur on the cylindrical member 1. According to Equation (1.7), which shows that [Q]₁₆⁻¹≠0, the shear stress τ_{xy} generates the perpendicular strain εₓ determined by Equation (1.4). In the orthogonal coordinate system O-XYZ, εₓ is a circumferential strain of the cylindrical member 1 and represents the amount of radial deformation. When [Q]₁₆⁻¹>0, exertion of the torsional moment M_{T} on the cylindrical member 1 in the direction illustrated in FIG. 1 leads to shear stress τ_{xy}>0, hence εₓ>0, thereby causes the cylindrical member 1 to expand in the radial direction. On the contrary, when [Q]₁₆⁻¹<0, exertion of the torsional moment M_{T} on the cylindrical member 1 in the direction illustrated in FIG. 1 leads to shear stress τ_{xy}>0, hence εₓ<0, thereby causes the cylindrical member 1 to contract in the radial direction. However, exertion of the torsional moment M_{T} in an opposite direction will cause the cylindrical member 1 to expand in the radial direction.

Next, a consideration is given to a metric for evaluating the amount of radial expansion when the torsional moment M_{T} is exerted. Note that the amount of radial expansion is hereinafter referred to as “torsion-expansion characteristic”. The amount of deformation when the torsional moment M_{T} is exerted on the cylindrical member 1 depends on the diameter and the thickness of the cylindrical member 1. Accordingly, evaluation of the amount of radial expansion can be made by comparison of the amount of strain per shear stress τ_{xy} produced by the torsional moment M_{T}. Equation (1.4) expresses a relationship between the shear stress τ_{xy} and the strain, and therefore [Q]₁₆⁻¹ function as an evaluation metric for the “torsion-expansion characteristic”.

$$\begin{matrix}Formula 10 & \\ \vert {[ Q ]}_{16}^{- 1} \vert = \frac{1}{\vert detQ \vert} \vert {Q}_{12} {Q}_{26} - {Q}_{16} {Q}_{22} \vert & ( 1.8 )\end{matrix}$$

Equations (1.4) and (1.5) show that, regarding cylindrical members 1 having a same inner diameter and a same thickness, a higher value obtained by Equation (1.8) results in a greater amount of radial expansion when a same magnitude of the torsional moment M_{T} is exerted on these cylindrical members 1. The cylindrical member 1 according to the present first embodiment desirably has a value of the right-hand side shown in Equation (1.8) of 0.002 [1/GPa] or higher, more desirably has this value of the right-hand side of 0.005 [1/GPa] or higher, and even more desirably has this value of the right-hand side of 0.01 [1/GPa] or higher. Note that 1/GPa, which is the unit of the foregoing values, is reciprocal of gigapascal (GPa), where 1 GPa=10⁹ newton per square meter (N/m²).

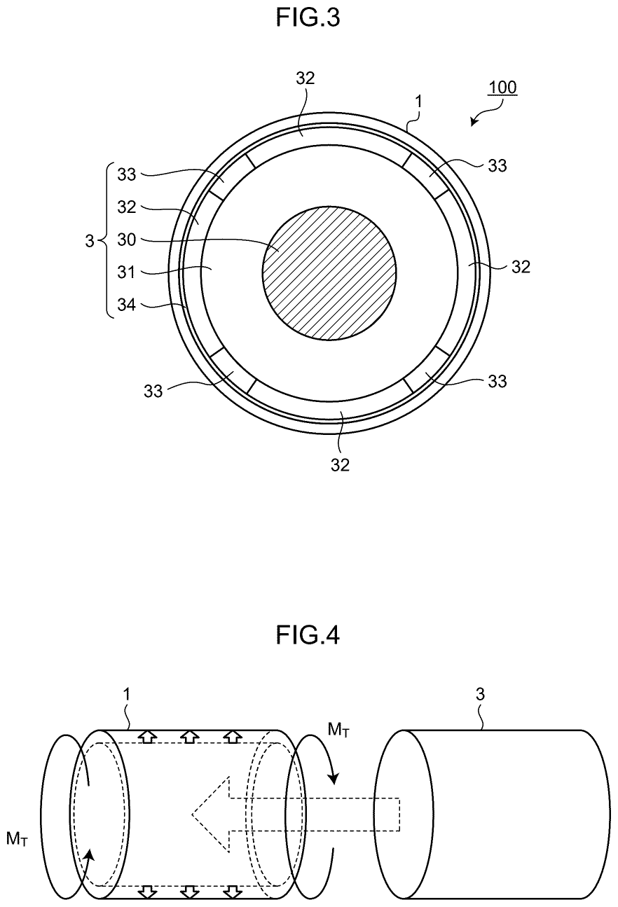

Referring to FIGS. 2 and 3, a surface magnet motor (surface permanent magnet: SPM) 100 including the cylindrical member 1 according to the present first embodiment will next be described. FIG. 2 is a perspective view illustrating a surface magnet motor including the cylindrical member according to the first embodiment. FIG. 3 is a front view of the surface magnet motor including the cylindrical member according to the first embodiment, as viewed from the axial direction.

As illustrated in FIGS. 2 and 3, the surface magnet motor 100 includes the cylindrical member 1 configured as described above and a rotor core unit 3, which is press fit into an inner diameter side of the cylindrical member 1.

The rotor core unit 3 includes a shaft 30, an iron core 31, permanent magnets 32, spacers 33, and a highly electrically conductive material 34. The shaft 30 is coaxially fit into the cylinder bore of the iron core 31 having a cylindrical shape. The permanent magnets 32 are arranged circumferentially spaced apart from each other on an outer circumferential surface of the iron core 31. The permanent magnets 32 are not limited to those forming four poles but can be arranged in any manner. The spacers 33 are each arranged between adjacent ones of the permanent magnets 32. The highly electrically conductive material 34 is disposed on outer circumferential surfaces of the permanent magnets 32 and of the spacers 33 to reduce rotor loss. The highly electrically conductive material 34 may be disposed on the entire outer circumferential surfaces of the permanent magnets 32 and of the spacers 33 or may be disposed on part of the outer circumferential surfaces of the permanent magnets 32 and of the spacers 33. The cylindrical member 1 is placed around the outer circumferential surface of the highly electrically conductive material 34. The cylindrical member 1 is a sleeve for securing the permanent magnets 32.

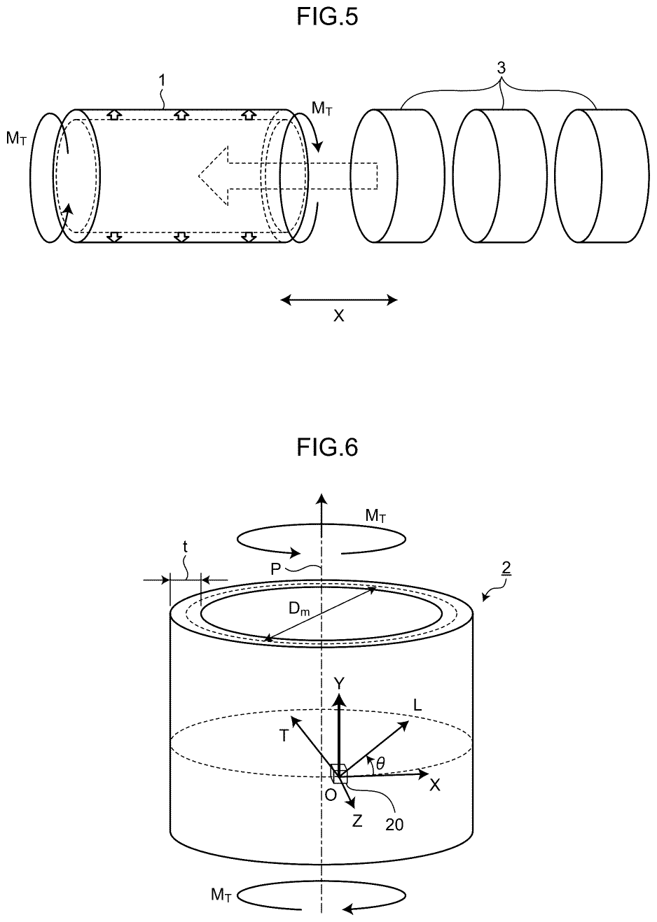

Referring to FIGS. 4 and 5, a method for producing the surface magnet motor 100 including the cylindrical member 1 according to the present first embodiment will next be described. FIG. 4 is an illustrative diagram illustrating a method for producing the surface magnet motor including the cylindrical member according to the first embodiment. As illustrated in FIG. 4, the method for producing the surface magnet motor 100 is started with exerting the torsional moment M_{T} on the cylindrical member 1. Exertion of the torsional moment M_{T} causes the cylindrical member 1 to expand in the radial direction. Next, with the torsional moment M_{T} being kept exerted on the cylindrical member 1, the rotor core unit 3 is press fit into the inner diameter side of the cylindrical member 1. After the rotor core unit 3 is press fit into the inner diameter side of the cylindrical member 1, the torsional moment M_{T} exerted on the cylindrical member 1 is removed. This causes the cylindrical member 1 to contract in the radial direction. The cylindrical member 1 is however radially constrained by the rotor core unit 3, thereby generating tension in the circumferential direction. Reaction to the tension causes a distributed load to act in the radial direction on the outer circumferential surface of the rotor core unit 3. This distributed load acts in a direction that prevents centrifugal separation of the permanent magnets 32 from the iron core 31 during rotation of the surface magnet motor 100.

FIG. 5 is an illustrative diagram illustrating a method for producing multiple surface magnet motors including the cylindrical member according to the first embodiment. As illustrated in FIG. 5, the method for producing the surface magnet motor 100 also allows multiple rotor core units 3 to be fit into the single cylindrical member 1. With the torsional moment M_{T} being kept exerted on the cylindrical member 1, the multiple rotor core units 3 are press fit into the inner diameter side of the cylindrical member 1. In this process, the rotor core units 3 are disposed in such a manner that adjacent ones of the rotor core units 3 do not come into contact with each other in the cylindrical axial direction X. After all of the rotor core units 3 are press fit into the inner diameter side of the cylindrical member 1, the torsional moment M_{T} exerted on the cylindrical member 1 is removed. The cylindrical member 1 is then cut according to the axial lengths of the respective rotor core units 3. This enables the multiple surface magnet motors 100 to be produced at a time.

As described above, the cylindrical member 1 according to the present first embodiment is formed of a fiber reinforced plastic having a relationship expressed by Equation (1.7) above when the stress-strain relational equation in the XY-plane is expressed as shown by Equation (1.1) above in the orthogonal coordinate system O-XYZ, in which the origin O is the midpoint in the thickness direction, of the small-sized element 10 of the cylindrical member 1, the X-axis is along the tangent direction of the cylinder, the Y-axis is along a direction parallel to the axial direction of the cylinder, and the Z-axis is along the radial direction of the cylinder, σ is a stress vector, ε is a strain vector, τ is shear stress, γ is shear strain, and the element Qᵢⱼ is the i-th row, j-th column element of the in-plane rigidity matrix Q.

Thus, exertion of the torsional moment M_{T} on the cylindrical member 1 according to the present first embodiment causes the cylindrical member 1 to undergo not only shear deformation but also radial expansion of the cylindrical member 1, thereby enabling reduction in press fitting force for the rotor core unit 3 to be press fit into the inner diameter side of the cylindrical member 1. In addition, when the torsional moment M_{T} is released after the rotor core unit 3 is fit into the cylindrical member 1, circumferential tension is generated by a restoring force exerted when the cylindrical member 1 is about to restore the original shape from the expanded shape. This can prevent centrifugal separation of the permanent magnets 32 from the iron core 31 during rotation of the surface magnet motor 100.

### Second Embodiment

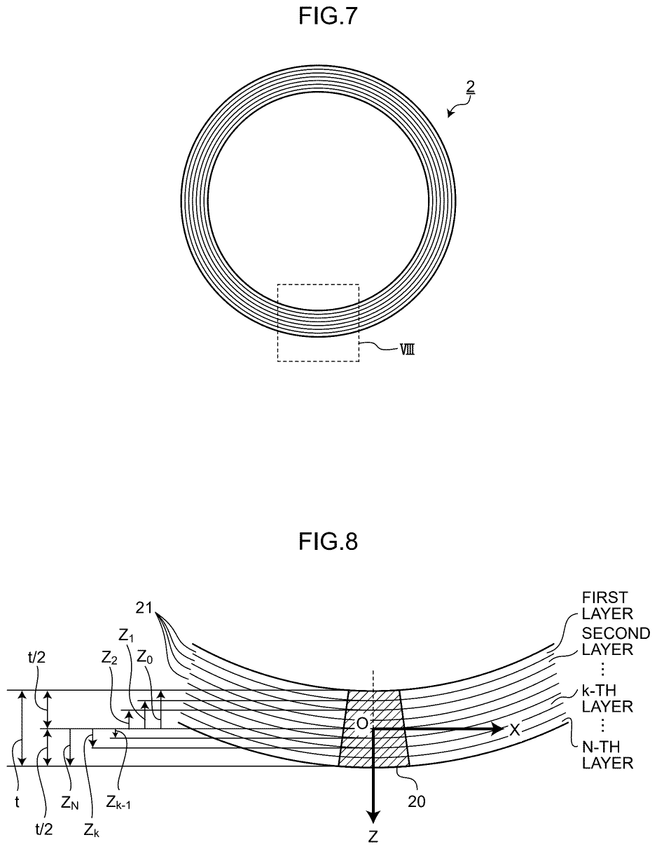

A cylindrical member 2 according to a present second embodiment will next be described. FIG. 6 is a perspective view illustrating a cylindrical member according to the second embodiment. FIG. 7 is a plan view of the cylindrical member according to the second embodiment, as viewed from the cylindrical axial direction. FIG. 8 is an enlarged view of portion VIII illustrated in FIG. 7.

To denote a direction for defining features of the cylindrical member 2, which is a material direction, the orthogonal coordinate system O-XYZ is defined in FIG. 6. The orthogonal coordinate system O-XYZ is a coordinate system in which, assuming a small-sized element 20 of the cylindrical member 2, the origin O is the midpoint in the thickness direction, of the small-sized element 20, an X-axis is along the tangent direction of the cylinder, a Y-axis is along a direction parallel to the axial direction P of the cylinder, and a Z-axis is along the radial direction of the cylinder. In addition, the direction of the torsional moment M_{T} exerted on the cylindrical member 2 is defined such that the right-hand screw direction around the cylindrical axis is the positive direction.

As illustrated in FIGS. 6 to 8, the cylindrical member 2 according to the present second embodiment is configured to include multiple fiber reinforced plastic layers (hereinafter referred to as FRP layers 21) each having a cylindrical shape. Adjacent ones of the FRP layers 21 are joined to each other. The joining method can be, for example, joining by adhesion. When, for example, sheet winding technique is used to produce the cylindrical member 2, all layers are wound and layered around a mandrel and are then subjected simultaneously to curing and adhesion between adjacent ones of the FRP layers 21. Alternatively, the cylindrical member 2 can also be produced by a method in which, of all layers of the FRP layers 21, only part of the adjacent ones of the FRP layers 21 are integrally formed in advance, and the integrally formed pieces are then bonded together using epoxy adhesive, acryl adhesive, or the like.

The joining method is not limited to the methods using the foregoing configurations. The FRP layers 21 are each formed of a reinforcement fiber and a resin, in which part or all of fibers of the reinforcement fiber, oriented in at least one direction, are continuous, and different combinations of reinforcement fiber and resin can be used in different layers of the FRP layers 21. The reinforcement fiber can be, for example, a carbon fiber or a glass fiber, as well as an organic fiber such as a para-aramid fiber or a polyester fiber. The resin can be a thermosetting resin such as an epoxy resin, an unsaturated polyester resin, or an epoxy acrylate resin, or a thermoplastic resin such as polyamide, polypropylene, polyethylene, polystyrene, polyethylene terephthalate, polycarbonate, polyetheretherketone, or polyphenylene sulfide.

Now, as illustrated in FIG. 6, let an L direction be the fiber direction of each of the FRP layers 21 (i.e., a tangent direction on the cylinder), and a T direction be a direction perpendicular to the L direction. The L direction is expressed by a rotation angle θ counterclockwise from the X-axis of the orthogonal coordinate system O-XYZ. The FRP layers 21 have N layers in total, which are called a first layer, a second layer, . . . , a k-th layer, . . . , and an N-th layer in order from inner to outer circumferences. Letting θk denote the L direction of the k-th layer, the relational equation of resultant force and strain in the XY plane of the cylindrical member 2 can be expressed by Equation (2.1) according to the classical lamination theory described in foregoing Reference Literature 1.

$$\begin{matrix}Formula 11 & \\ \{ N \} = \{ \begin{matrix}{N}_{x} \\ {N}_{y} \\ {N}_{xy}\end{matrix} \} = [ A ] \{ ε \} = [ \begin{matrix}{A}_{11} & {A}_{12} & {A}_{16} \\ {A}_{12} & {A}_{22} & {A}_{26} \\ {A}_{16} & {A}_{26} & {A}_{66}\end{matrix} ] \{ \begin{matrix}{ε}_{x} \\ {ε}_{y} \\ {γ}_{xy}\end{matrix} \} & ( 2.1 )\end{matrix}$$

In the equation, {N}={Nₓ N_{y} N_{xy}}^{T} is a resultant force vector, and {ε}={εₓ ε_{y} γ_{xy}}^{T} is a strain vector. In addition, an element Aᵢⱼ of an in-plane rigidity matrix [A] is expressed by Equation (2.2).

$$\begin{matrix}Formula 12 & \\ {A}_{ij} = {\sum }_{k = 1}^{N} {( {\overline{Q}}_{ij} )}_{k} ( {z}_{k} - {z}_{k - 1} ) \\ ( i , j = 1 , 2 , 6 ) & ( 2.2 )\end{matrix}$$

In the equation, zₖ is, as illustrated in FIG. 8, a Z coordinate at a radial boundary of the k-th layer. In addition, (Q(bar)ᵢⱼ)ₖ in Equation (2.2) is an element Q(bar)ᵢⱼ (i, j=1, 2, 6) of the stress-strain relational equation for the k-th layer, and is specifically given by Equations (2.3). Note that Q(bar) represents a letter Q with a bar over the letter.

$$\begin{matrix}Formula 13 & \\ \begin{matrix}{\overline{Q}}_{11} = {c}^{4} {Q}_{11} + {s}^{4} {Q}_{22} + 2 ( {Q}_{12} + 2 {Q}_{66} ) {c}^{2} {s}^{2} \\ {\overline{Q}}_{22} = {s}^{4} {Q}_{11} + {c}^{4} {Q}_{22} + 2 ( {Q}_{12} + 2 {Q}_{66} ) {c}^{2} {s}^{2} \\ {\overline{Q}}_{12} = ( {c}^{4} + {s}^{4} ) {Q}_{12} + ( {Q}_{11} + {Q}_{22} - 4 {Q}_{66} ) {c}^{2} {s}^{2} \\ {\overline{Q}}_{66} = ( {c}^{4} + {s}^{4} ) {Q}_{66} + ( {Q}_{11} + {Q}_{22} - 2 {Q}_{12} - 2 {Q}_{66} ) {c}^{2} {s}^{2} \\ {\overline{Q}}_{16} = ( {Q}_{11} - {Q}_{12} - 2 {Q}_{66} ) {c}^{3} s + ( {Q}_{12} - {Q}_{22} + 2 {Q}_{66} ) {cs}^{3} \\ {\overline{Q}}_{26} = ( {Q}_{11} - {Q}_{12} - 2 {Q}_{66} ) {cs}^{3} + ( {Q}_{12} - {Q}_{22} + 2 {Q}_{66} ) {c}^{3} s\end{matrix} & ( 2.3 )\end{matrix}$$

where c=cos θₖ and s=sin θₖ

In Equations (2.3), Q₁₁, Q₂₂, Q₁₂, and Q₆₆ are expressed by Equations (2.4).

$$\begin{matrix}Formula 14 & \\ \begin{matrix}{Q}_{11} = {mE}_{L} \\ {Q}_{22} = {mE}_{T} \\ {Q}_{12} = {mv}_{LT} {E}_{T} \\ {Q}_{66} = m {G}_{LT} \\ m = 1 / ( 1 - {v}_{LT}^{2} {E}_{T} / {E}_{L} )\end{matrix} & ( 2.4 )\end{matrix}$$

In Equations (2.4), E_{L} is a tensile modulus of elasticity in the L direction of the k-th layer, E_{T} is a tensile modulus of elasticity in the T direction of the k-th layer, ν_{LT} is a Poisson ratio in the LT direction of the k-th layer, and G_{LT} is a shear modulus of elasticity in the LT direction.

Solving Equation (2.1) for {ε} provides Equation (2.5), and thus Equation (2.6) is obtained.

$$\begin{matrix}Formula 15 & \\ \{ \begin{matrix}{ε}_{x} \\ {ε}_{y} \\ {γ}_{xy}\end{matrix} \} = {[ A ]}^{- 1} \{ \begin{matrix}{N}_{x} \\ {N}_{y} \\ {N}_{xy}\end{matrix} \} & ( 2.5 )\end{matrix}$$

$$\begin{matrix}Formula 16 & \\ {ε}_{x} = {[ A ]}_{11}^{- 1} \cdot {N}_{x} + {[ A ]}_{12}^{- 1} \cdot {N}_{y} + {[ A ]}_{16}^{- 1} \cdot {N}_{xy} & ( 2.6 )\end{matrix}$$

In Equation (2.6), [A]ᵢⱼ⁻¹ is an ij-th element of the inverse matrix of the matrix [A]. Assuming that there is only shear resultant force N_{xy} caused by torsion (i.e., Nₓ=N_{y}=0), Equation (2.7) is obtained. The element [A]₁₆⁻¹ is expressed by Equation (2.8).

$$\begin{matrix}Formula 17 & \\ {ε}_{x} = {[ A ]}_{16}^{- 1} \cdot {N}_{xy} & ( 2.7 )\end{matrix}$$

$$\begin{matrix}Formula 18 & \\ {[ A ]}_{16}^{- 1} = \frac{1}{detA} ( {A}_{12} {A}_{26} - {A}_{16} {A}_{22} ) & ( 2.8 )\end{matrix}$$

In Equation (2.8), detA is the determinant of the matrix [A], and is expressed by Equation (2.9).

$$\begin{matrix}Formula 19 & \\ detA = {A}_{11} {A}_{22} {A}_{66} + {A}_{12} {A}_{26} {A}_{16} + {A}_{16} {A}_{12} {A}_{26} - {A}_{11} {A}_{26} {A}_{66} - {A}_{12} {A}_{12} {A}_{66} - {A}_{16} {A}_{22} {A}_{16} & ( 2.9 )\end{matrix}$$

The cylindrical member 2 according to the present second embodiment is characterized in satisfying Equation (2.10).

$$\begin{matrix}Formula 20 & \\ {A}_{12} {A}_{26} - {A}_{16} {A}_{22} \neq 0 & ( 2.1 )\end{matrix}$$

By satisfying Equation (2.10), the cylindrical member 2 has the following feature. That is, exertion of the torsional moment M_{T} on the cylindrical member 2 causes the shear resultant force N_{xy} to occur on the cylindrical member 2. According to Equation (2.10), which shows that [A]₁₆⁻¹≠0, the shear resultant force N_{xy} generates the perpendicular strain εₓ determined by Equation (2.7). In the orthogonal coordinate system O-XYZ, εₓ is a circumferential strain of the cylindrical member 2, and represents the amount of radial deformation. When [A]₁₆⁻¹>0, exertion of the torsional moment M_{T} on the cylindrical member 2 in the direction illustrated in FIG. 6 leads to shear resultant force N_{xy}>0, hence εₓ>0, thereby causes the cylindrical member 2 to expand in the radial direction. On the contrary, when [A]₁₆⁻¹<0, exertion of the torsional moment M_{T} on the cylindrical member 2 in the direction illustrated in FIG. 6 leads to shear resultant force N_{xy}>0, hence εₓ<0, thereby causes the cylindrical member 2 to contract in the radial direction. However, exertion of the torsional moment M_{T} in an opposite direction will cause the cylindrical member 2 to expand in the radial direction.

In this respect, N_{xy} is an integrated value of the shear stress τ_{xy} of each of the FRP layers 21 along the plate thickness direction. Accordingly, when average shear stress τ(bar)_{xy} is defined as a quotient of N_{xy} obtained by division by a plate thickness “t” of the cylindrical member 2 as given by Equation (2.11), Equation (2.7) can be rewritten as Equation (2.12), and t/detA×(A₁₂A₂₆−A₁₆A₂₂) can be used as an evaluation metric for the “torsion-expansion characteristic”. Note that τ(bar) represents a letter τ with a bar over the letter.

$$\begin{matrix}Formula 21 & \\ {\overline{τ}}_{xy} = \frac{{N}_{xy}}{t} & ( 2.11 )\end{matrix}$$

$$\begin{matrix}Formula 22 & \\ {ε}_{x} = {[ {A}^{- 1} ]}_{16} \cdot t \cdot {\overline{τ}}_{xy} = \{ \frac{t}{detA} ( {A}_{12} {A}_{26} - {A}_{16} {A}_{22} ) \} \cdot {\overline{τ}}_{xy} & ( 2.12 )\end{matrix}$$

$$\begin{matrix}Formula 23 & \\ \vert {[ A ]}_{16}^{- 1} \cdot t \vert = \frac{t}{\vert detA \vert} \vert {A}_{12} {A}_{26} - {A}_{16} {A}_{22} \vert & ( 2.13 )\end{matrix}$$

Equation (2.12) shows that, regarding cylindrical members 2 having a same dimension, a higher value obtained by Equation (2.13) results in a greater amount of radial expansion when a same magnitude of the torsional moment M_{T} is exerted on these cylindrical members 2. The cylindrical member 2 according to the present second embodiment desirably has a value of the right-hand side shown in Equation (2.13) of 0.002 [1/GPa] or higher, more desirably has this value of the right-hand side of 0.005 [1/GPa] or higher, and even more desirably has this value of the right-hand side of 0.01 [1/GPa] or higher. Note that 1/GPa, which is the unit of the foregoing values, is reciprocal of GPa, where 1 GPa=10⁹ newton per square meter (N/m²).

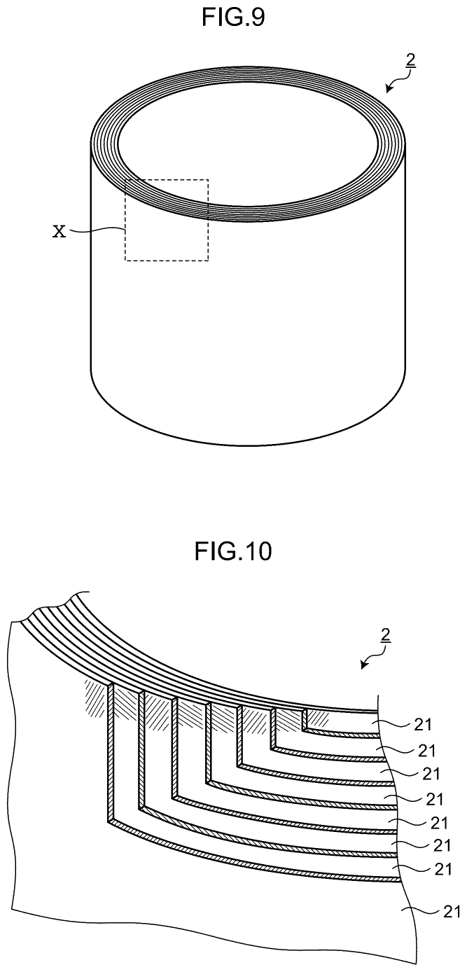

Referring to FIGS. 9 and 10 and also to FIG. 6, a specific example of the cylindrical member 2 according to the present second embodiment will next be described. FIG. 9 is a perspective view illustrating a specific example of the cylindrical member according to the second embodiment. FIG. 10 is an enlarged view of portion X illustrated in FIG. 9, illustrated with virtual cut planes.

Table 1 provides the material of each of the FRP layers 21, the thickness of each of the FRP layers 21, and the fiber directions, in the cylindrical member 2. Table 2 provides types of material constants and physical property values of material A given in Table 1, which is assumed to be a unidirectionally reinforced prepreg formed of a PAN-based high-strength carbon fiber and an epoxy resin. PAN stands for polyacrylonitrile.

TABLE 1

| FRP Layers | Material | Thickness (mm) | θ k |
|---|---|---|---|
| First Layer | Material | 0.125 | 60° |
| Second Layer | | | −25° |
| Third Layer | | | 60° |
| Fourth Layer | | | −25° |
| Fifth Layer | | | −25° |
| Sixth Layer | | | 60° |
| Seventh Layer | | | −25° |
| Eighth Layer | | | 60° |

TABLE 2

| Material | Physical | |
|---|---|---|
| Constant | Property Value | |
| E_{L} | 130.1 | GPa |
| E_{T} | 8.03 | GPa |
| ν_{LT} | 0.31 | |
| G_{LT} | 4.8 | GPa |

The cylindrical member 2 as given in Tables 1 and 2 has a value of t/|detA|×|A₁₂A₂₆−A₁₆A₂₂| calculated as shown by Equation (2.14).

$$\begin{matrix}Formula 24 & \\ \frac{t}{\vert detA \vert} \vert {A}_{12} {A}_{26} - {A}_{16} {A}_{22} \vert = 0.0373 ( 1 \text{/GPa} ) & ( 2.14 )\end{matrix}$$

The average shear stress τ(bar)_{xy} can be approximately determined as shown by Equation (2.15), where Dₘ represents the diameter of a plate thickness center portion of the cylindrical member 2, and ΔDₘ represents the amount of expansion of the diameter Dₘ caused by the torsional moment M_{T}, as illustrated in FIG. 6.

$$\begin{matrix}Formula 25 & \\ {\overline{τ}}_{xy} ≅ \frac{{M}_{T}}{2 ( \frac{π {D}_{m}^{2}}{4} ) t} = \frac{2 {M}_{T}}{π {D}_{m}^{2} t} & ( 2.15 )\end{matrix}$$

In addition, L, representing the circumferential length of the plate thickness center portion of the cylindrical member 2, and ΔL, representing the amount of elongation of the circumferential length L, have a relationship of Equation (2.16), and the amount of diameter expansion ΔDₘ is therefore given by Equation (2.17).

$$Formula 26$$

$${ε}_{x} = \frac{Δ L}{L} = \frac{πΔ {D}_{m}}{π {D}_{m}} = \frac{Δ {D}_{m}}{{D}_{m}} \qquad ( 2.16 )$$

$$Formula 27$$

$$\frac{Δ {D}_{m}}{{D}_{m}} = \frac{t}{\vert det A \vert} \vert {A}_{12} {A}_{26} - {A}_{16} {A}_{22} \vert \cdot \frac{2 {M}_{T}}{π {D}_{m}^{2} t} \qquad ( 2.17 )$$

$$∴ Δ {D}_{m} = \frac{t}{\vert det A \vert} \vert {A}_{12} {A}_{26} - {A}_{16} {A}_{22} \vert \cdot \frac{2 {M}_{T}}{π {D}_{m} t}$$

From Equation (2.17), the amount of diameter expansion ΔDₘ can be determined to be 0.119 mm when the torsional moment M_{T} is 500 newton-meter (Nm) and the diameter Dₘ is 100 mm.

Another specific example of the cylindrical member 2 according to the present second embodiment will next be described. Table 3 provides the material of each of the FRP layers 21, the thickness of each of the FRP layers 21, and the fiber directions, in the cylindrical member 2. Table 4 provides types of material constants and physical property values of material B given in Table 3, which is assumed to be a unidirectionally reinforced prepreg formed of a pitch-based highly elastic carbon fiber and an epoxy resin.

TABLE 3

| FRP Layers | Material | Thickness (mm) | θ k |
|---|---|---|---|
| First Layer | Material B | 0.125 | −20° |
| Second Layer | | | 55° |
| Third Layer | | | −20° |
| Fourth Layer | | | 55° |
| Fifth Layer | | | 55° |
| Sixth Layer | | | −20° |
| Seventh Layer | | | 55° |
| Eighth Layer | | | −20° |

TABLE 4

| Material | Physical | |
|---|---|---|
| Constant | Property Value | |
| E_{L} | 350 | GPa |
| E_{T} | 5 | GPa |
| ν_{LT} | 0.33 | |
| G_{LT} | 4.2 | GPa |

A high modulus of elasticity of the FRP layers 21 will cause a high tension to act on the cylindrical member 2 after the cylindrical member 2 is placed around the outer circumferential surface of the rotor core unit 3. This can generate force to prevent separation or flying off of the permanent magnets 32 from the cylindrical member 2 due to centrifugal force caused by high-speed rotation of the surface magnet motor 100. The fiber to be used for the FRP layers 21 is therefore desirably a pitch-based highly elastic carbon fiber. In addition, the fiber desirably has a tensile modulus of elasticity in the fiber direction of 300 GPa or higher. The parameter t/|detA|×|A₁₂A₂₆−A₁₆A₂₂| is calculated for such cylindrical member 2 as shown by Equation (2.18).

$$Formula 28$$

$$\frac{t}{\vert det A \vert} \vert {A}_{12} {A}_{26} - {A}_{16} {A}_{22} \vert = 0.0356 ( 1 / GPa ) \qquad ( 2.18 )$$

In addition, from Equation (2.17), the amount of diameter expansion ΔDₘ can be determined to be 0.113 mm when the torsional moment M_{T} is 500 newton-meter (Nm) and the diameter Dₘ is 100 mm.

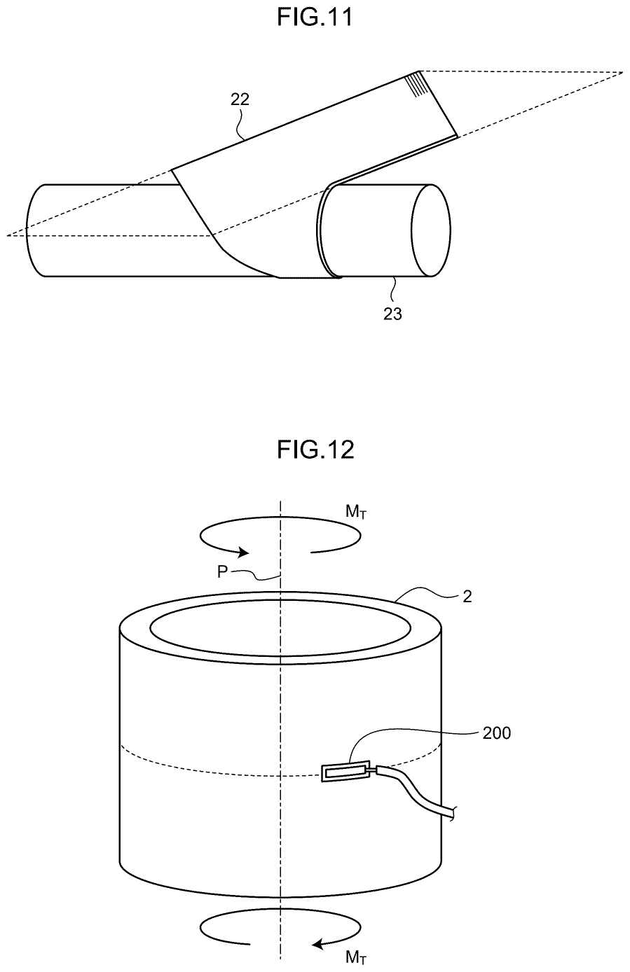

Referring to FIG. 11, a method for producing the cylindrical member 2 according to the present second embodiment will next be described. FIG. 11 is an illustrative diagram schematically illustrating an example of method for producing the cylindrical member according to the second embodiment. In a case where the resin is a thermosetting resin, examples of the method for producing the cylindrical member 2 include sheet winding technique and filament winding technique. As illustrated in FIG. 11, the sheet winding technique is a method in which a unidirectionally oriented continuous fiber is preliminarily impregnated with resin, a semicured prepreg 22 is wound around a cylinder or a mandrel 23 having a cylindrical shape, and the prepreg 22 is then cured. The filament winding technique is a method in which fiber tows are impregnated with an uncured liquid thermosetting resin, are wound around a mandrel, and are then cured. Alternatively, in a case where the resin is a thermoplastic resin, examples of the method for producing the cylindrical member 2 include an automated tape placement (ATP) technique. The ATP technique is a method in which tapes or sheet-shaped matrices produced by preliminary impregnation of a unidirectionally oriented continuous fiber with a resin are wound around a mandrel jig with heating and pressurization for adhesion. Note that the method for producing the cylindrical member 2 is not limited to a production method that uses the sheet winding technique, the filament winding technique, or the ATP technique, but may be another method.

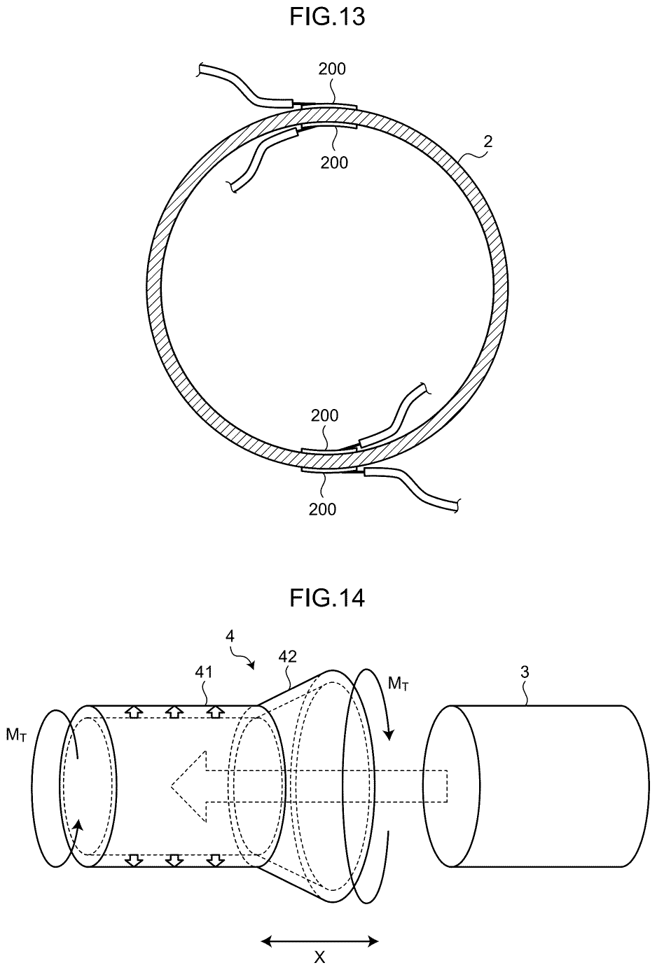

Referring to FIGS. 12 and 13, a method for evaluating the “torsion-expansion characteristic” of the cylindrical member 2 will next be described. FIG. 12 is a perspective view illustrating a method for evaluating the “torsion-expansion characteristic” of the cylindrical member according to the second embodiment. FIG. 13 is a transverse cross-sectional view illustrating the method for evaluating the “torsion-expansion characteristic” of the cylindrical member according to the second embodiment. As illustrated in FIGS. 12 and 13, strain gages 200 are bonded on the outer circumferential surface and on the inner circumferential surface of the cylindrical member 2. The strain gages 200 each measure the circumferential, perpendicular strain εₓ when the torsional moment M_{T} is exerted on the cylindrical member 2. The strain gages 200 measure strain in the circumferential direction of the cylindrical member 2. The measurement points used by the strain gages 200 are not limited to the two points illustrated in FIG. 13, but use of one or more points is sufficient. The circumferential, perpendicular strain εₓ can be determined by Equation (2.19) below using Equations (2.16) and (2.17). The “torsion-expansion characteristic” can be evaluated by comparing the measurement value of the strain gages 200 with the value determined by Equation (2.19).

$$Formula 29$$

$$\begin{matrix}{ε}_{x} = {[ {A}^{- 1} ]}_{16} \cdot t \cdot {\overline{τ}}_{xy} \\ = \{ \frac{t}{det A} ( {A}_{12} {A}_{26} - {A}_{16} {A}_{22} ) \} \cdot {\overline{τ}}_{xy} \\ = \{ \frac{t}{det A} ( {A}_{12} {A}_{26} - {A}_{16} {A}_{22} ) \} \cdot \frac{2 {M}_{T}}{π {D}_{m}^{2} t}\end{matrix} \qquad ( 2.19 )$$

Note that the cylindrical member 2 according to the present second embodiment also enables the surface magnet motor 100 to be produced in which the rotor core unit 3 is press fit into the inner diameter side of the cylindrical member 2, using the foregoing method for producing the surface magnet motor 100.

As described above, the fiber reinforced plastic that forms the cylindrical member 2 according to the present second embodiment includes the multiple FRP layers 21, in which part or all of fibers are formed of continuous fibers. The fiber reinforced plastic is formed to satisfy a relationship expressed by Equation (2.10) above, in which the element Aᵢⱼ is expressed as shown by Equation (2.2) above, where N represents a resultant force vector of the FRP layers 21, the element Aᵢⱼ is the i-th row, j-th column element of the equivalent in-plane rigidity matrix A calculated according to the classical lamination theory, and the resultant force-strain relational equation in the XY-plane is expressed as shown by Equation (2.1) above. The element Qᵢⱼ(bar) shown in Equation (2.2) above is expressed as shown by Equations (2.3) and (2.4) above, where an L direction is the fiber direction of each of the FRP layers 21, a T direction is a direction perpendicular to the L direction, and the L direction is expressed by a rotation angle θ counterclockwise from the X-axis.

Thus, exertion of the torsional moment M_{T} on the cylindrical member 2 according to the present second embodiment causes the cylindrical member 2 to undergo not only shear deformation but also radial expansion of the cylindrical member 2, thereby enabling reduction in press fitting force for the rotor core unit 3 to be press fit into the inner diameter side of the cylindrical member 2. In addition, when the torsional moment M_{T} is released after the rotor core unit 3 is fit into the cylindrical member 2, circumferential tension is generated by a restoring force exerted when the cylindrical member 2 is about to restore the original shape from the expanded shape. This can prevent centrifugal separation of the permanent magnets 32 from the iron core 31 during rotation of the surface magnet motor 100.

### Third Embodiment

A tapered part-attached cylindrical member 4 according to a present third embodiment and the surface magnet motor 100 produced using the tapered part-attached cylindrical member 4 will next be described. FIG. 14 is an illustrative diagram illustrating a method for producing the surface magnet motor using a tapered part-attached cylindrical member according to the third embodiment. As illustrated in FIG. 14, the tapered part-attached cylindrical member 4 according to the present third embodiment includes a straight body part 41, which consists of the cylindrical member 1 of the first embodiment or the cylindrical member 2 of the second embodiment, and a tapered part 42 having a cylindrical shape, which is connected to one end side in the cylindrical axial direction X of the straight body part 41, and has an inner diameter expanding along the cylindrical axial direction X from the one end side where connection to the straight body part 41 is made. The rotor core unit 3 of the surface magnet motor 100 is press fit into the straight body part 41. Thus, what is required is that at least the straight body part 41 satisfy Equation (1.7) or Equation (2.10). Note that the tapered part 42 may also satisfy Equation (1.7) or Equation (2.10). The straight body part 41 and the tapered part 42 are integrally formed. The tapered part 42 is provided to attach a twisting jig 51b described later.

When the straight body part 41 corresponds to the cylindrical member 2 of the second embodiment, the tapered part-attached cylindrical member 4 is produced using, for example, the sheet winding technique. In this case, semicured prepreg plies are wound and layered around a combination of mandrels formed of a mandrel having an outer diameter shape of the shape of the straight body part 41 and a mandrel having an outer diameter shape corresponding to the inner diameter of the tapered part 42, and prepreg plies adjacent to each other in the lamination direction are cured and bonded at one time. This enables production of the tapered part-attached cylindrical member 4 including the straight body part 41 and the tapered part 42.

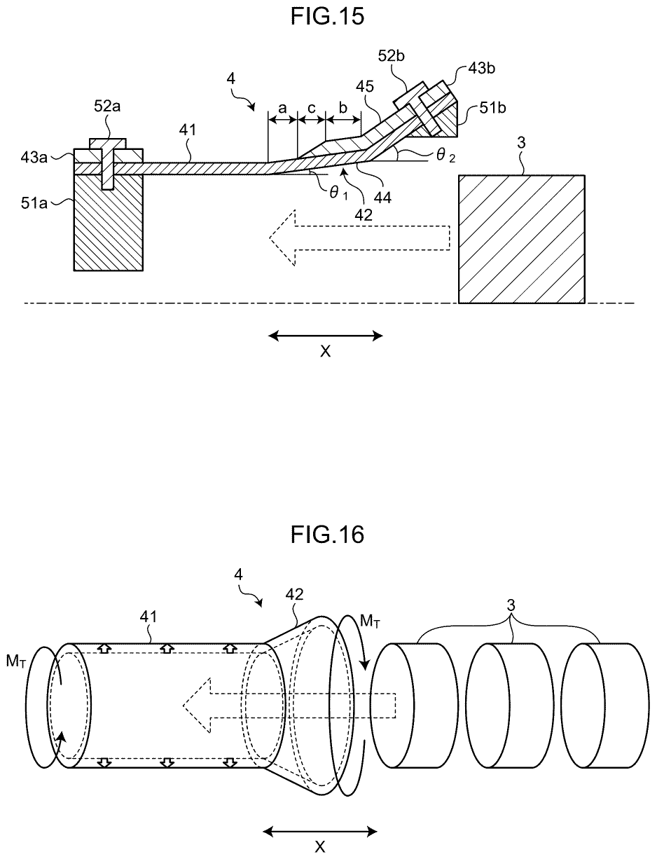

FIG. 15 is a cross-sectional view of part of the tapered part-attached cylindrical member according to the third embodiment, taken along the cylindrical axial direction. As illustrated in FIG. 15, a doubler 43a for reinforcement is provided on the outer circumferential surface near an opening of the cylinder body of the straight body part 41. In addition, a doubler 43b for reinforcement is provided on the outer circumferential surface near an opening of the cylinder body of the tapered part 42. This causes the straight body part 41 and the tapered part 42 to have plate thicknesses near the cylindrical openings where the doubler 43a and the doubler 43b are provided to be greater than the plate thickness of a portion where neither the doubler 43a nor the doubler 43b is provided. The doubler 43a and the doubler 43b can be formed by, for example, increasing the number of prepreg plies used in sheet winding during production. Alternatively, another method for forming the doubler 43a and the doubler 43b is to bond and join separately produced cylindrical members on the outer circumferential surface of the straight body part 41 and on the outer circumferential surface of the tapered part 42. The doubler 43a and the doubler 43b do not need to satisfy Equation (1.7) or Equation (2.10), and the materials thereof can be arbitrarily selected. For higher workability, a cloth material may be used on the surfaces of the doubler 43a and the doubler 43b. Note that the tapered part-attached cylindrical member 4 is not limited to one that is configured to include doublers on the straight body part 41 and the tapered part 42, but may be configured to include a doubler at least one of the straight body part 41 and the tapered part 42.

In addition, the tapered part 42 has multiple taper angles that gradually increase along the cylindrical axial direction X, starting from the one end side where connection to the straight body part 41 is made. The tapered part 42 illustrated in FIG. 15 includes, by way of example, a first tapered part 44 having a taper angle θ₁, connected to the straight body part 41, and a second tapered part 45 having a taper angle θ₂, which is greater than the taper angle θ₁. The taper angle θ₁ of the first tapered part 44 is, by way of example, 1°, 2°, or 5°. The taper angle θ₂ of the second tapered part 45 is, by way of example, 10°, 20°, 30°, or 45°. Note that the taper angle θ₁ of the first tapered part 44 and the taper angle θ₂ of the second tapered part 45 are not limited to the above angles, but it is merely required that the taper angle θ₁ is less than the taper angle θ₂. In addition, the tapered part 42 is not limited to one configured to have two taper angles of the taper angle θ₁ and the taper angle θ₂, but may be configured to have one taper angle or three or more taper angles.

Moreover, the doubler 43b provided on the tapered part 42 is not disposed in a portion near the straight body part 41 of the first tapered part 44, but is arranged uninterruptedly over a part of the first tapered part 44 and the entire length of the second tapered part 45. In the first tapered part 44, the doubler 43b is desirably provided to include a portion “a” having a plate thickness identical to the plate thickness of the straight body part 41, a portion “b” having a plate thickness identical to the plate thickness of the second tapered part 45 on which the doubler 43b is provided, and a portion “c” disposed therebetween, having a plate thickness that changes continuously. When the tapered part 42 has a large taper angle, exertion of the torsional moment M_{T} will cause the tapered part-attached cylindrical member 4 to be subjected to an anomalous condition in which high stress occurs at the joint between the straight body part 41 and the tapered part 42, which may cause a fracture to occur from that joint. The tapered part-attached cylindrical member 4 according to the present third embodiment includes the first tapered part 44 having a small taper angle. This can prevent occurrence of an anomalous condition of stress at the joint between the straight body part 41 and the tapered part 42. Moreover, the tapered part-attached cylindrical member 4 includes the doubler 43b over a part of the first tapered part 44 and the second tapered part 45, which can improve strength of the tapered part 42. This enables the tapered part-attached cylindrical member 4 to prevent a fracture at the joint between the first tapered part 44 and the second tapered part 45 even when anomalous high stress occurs at that joint.

A method for producing the surface magnet motor 100 using the tapered part-attached cylindrical member 4 according to the present third embodiment will next be described. As illustrated in FIG. 15, a twisting jig 51a having a cylindrical shape is provided in the cylinder bore of the straight body part 41. In addition, the twisting jig 51b having a cylindrical shape is provided in the cylinder bore of the tapered part 42. The twisting jig 51a provided in the cylinder bore of the straight body part 41 is disposed to at least partly face the doubler 43a provided on the outer circumferential surface, and is fixed by tightening a bolt 52a through the doubler 43a and the straight body part 41. Tightening the bolt 52a through a portion of providing the doubler 43a allows mitigation of stress concentration caused by bolt tightening. In addition, the twisting jig 51b provided in the cylinder bore of the tapered part 42 is disposed to at least partly face the doubler 43b provided on the outer circumferential surface of the second tapered part 45, and is fixed by tightening a bolt 52b through the doubler 43b and the second tapered part 45. Tightening the bolt 52b through a portion of providing the doubler 43b allows mitigation of stress concentration caused by bolt tightening. In this respect, the twisting jig 51b provided in the cylinder bore of the tapered part 42 is designed to have an inner diameter greater than the outer diameter of the rotor core unit 3 to allow the rotor core unit 3 to pass through the cylinder bore of the twisting jig 51b. Note that the twisting jigs 51a and 51b are not limited to those that are configured to be fixed in the cylinder bore of the straight body part 41 and the cylinder bore of the tapered part 42, but may be fixed on the outer circumferential surface of the straight body part 41 and the outer circumferential surface of the tapered part 42. In addition, the twisting jigs 51a and 51b may be fixed to the straight body part 41 and the tapered part 42 using, for example, a method of bonding using an adhesive such as an epoxy adhesive or an acrylic adhesive, a method of fixing by friction, or a method combining any of these methods and bolt tightening.

The method for producing the surface magnet motor 100 is performed in such a manner that the torsional moment M_{T} is exerted on the twisting jig 51a and the twisting jig 51b as illustrated in FIG. 14 by holding the twisting jigs 51a and 51b provided on both sides, causing the torsional moment M_{T} to be transferred to the tapered part-attached cylindrical member 4. This causes the straight body part 41 to expand in the radial direction. With the torsional moment M_{T} being kept exerted on the tapered part-attached cylindrical member 4, the rotor core unit 3 is inserted into the inner diameter side of the twisting jig 51b fixed to the tapered part 42, and is then press fit inside the straight body part 41. In the tapered part-attached cylindrical member 4, the twisting jig 51b fixed on the tapered part 42 has an inner diameter greater than the outer diameter of the rotor core unit 3. This enables the rotor core unit 3 to be installed in the cylinder bore of the tapered part-attached cylindrical member 4 without interference between the rotor core unit 3 and the twisting jig 51b. After the rotor core unit 3 is fit inside the straight body part 41, the torsional moment M_{T} exerted on the twisting jig 51a and the twisting jig 51b is removed. This causes tension to be generated in the circumferential direction of the tapered part-attached cylindrical member 4. Reaction to that tension causes a distributed load to act in the radial direction on the outer circumferential surface of the rotor core unit 3. This distributed load acts in a direction that prevents centrifugal separation of the permanent magnets 32 from the iron core 31 during rotation of the surface magnet motor 100. The twisting jig 51a and the twisting jig 51b are then detached from the tapered part-attached cylindrical member 4. After this, the tapered part 42 is separated from the straight body part 41, thereby enabling the surface magnet motor 100 to be produced.

FIG. 16 is an illustrative diagram illustrating a method for producing multiple surface magnet motors using the tapered part-attached cylindrical member according to the third embodiment. As illustrated in FIG. 16, the method for producing the surface magnet motor 100 also allows multiple rotor core units 3 to be fit into the single tapered part-attached cylindrical member 4. Exertion of the torsional moment M_{T} on the twisting jig 51a and the twisting jig 51b causes the torsional moment M_{T} to be transferred to the tapered part-attached cylindrical member 4, and causes the straight body part 41 to expand in the radial direction. With the torsional moment M_{T} being kept exerted on the tapered part-attached cylindrical member 4, the multiple rotor core units 3 are inserted into the inner diameter side of the twisting jig 51b fixed on the tapered part 42, and are then press fit inside the straight body part 41. In this process, the rotor core units 3 are disposed in such a manner that adjacent ones of the rotor core units 3 do not come into contact with each other in the cylindrical axial direction X. After all of the rotor core units 3 are fit inside the straight body part 41, the torsional moment M_{T} exerted on the twisting jig 51a and the twisting jig 51b is removed. The twisting jig 51a and the twisting jig 51b are then detached from the tapered part-attached cylindrical member 4. After this, the tapered part-attached cylindrical member 4 is cut according to the axial lengths of the respective rotor core units 3. This enables the multiple surface magnet motors 100 to be produced at a time.

As described above, the tapered part-attached cylindrical member 4 according to the present third embodiment includes the straight body part 41, which consists of a cylindrical member corresponding to the cylindrical member 1 of the first embodiment or the cylindrical member 2 of the second embodiment, and the tapered part 42 having a cylindrical shape, which is connected to one end side in the cylindrical axial direction X of the straight body part 41, and expanding along the cylindrical axial direction X. That is, the straight body part 41 is formed to satisfy a relationship expressed by Equation (1.7) or Equation (2.10) above.

Thus, exertion of the torsional moment M_{T} on the tapered part-attached cylindrical member 4 according to the present third embodiment causes the tapered part-attached cylindrical member 4 to undergo not only shear deformation but also radial expansion of the straight body part 41, thereby enabling reduction in press fitting force for the rotor core unit 3 to be press fit into the inner diameter side of the straight body part 41. In addition, in the tapered part-attached cylindrical member 4, the twisting jig 51b fixed on the tapered part 42 has an inner diameter greater than the outer diameter of the rotor core unit 3. This enables the rotor core unit 3 to be installed in the cylinder bore of the tapered part-attached cylindrical member 4 without interference between the rotor core unit 3 and the twisting jig 51b. In addition, when the torsional moment M_{T} is released after the rotor core unit 3 is fit into the straight body part 41, circumferential tension is generated by a restoring force exerted when the straight body part 41 is about to restore the original shape from the expanded shape. This can prevent centrifugal separation of the permanent magnets 32 from the iron core 31 during rotation of the surface magnet motor 100.

The configurations described in the foregoing embodiments are merely examples. These configurations may be combined with another known technology, and configurations of different embodiments may be combined together. Moreover, such configurations may be partly omitted and/or modified without departing from the gist.

### REFERENCE SIGNS LIST

1, 2 cylindrical member; 3 rotor core unit; 4 tapered part-attached cylindrical member; 10, 20 small-sized element; 21 FRP layer; 22 prepreg; 23 mandrel; 30 shaft; 31 iron core; 32 permanent magnet; 33 spacer; 34 highly electrically conductive material; 41 straight body part; 42 tapered part; 43a, 43b doubler; 44 first tapered part; 45 second tapered part; 51a, 51b twisting jig; 52a, 52b bolt; 100 surface magnet motor; 200 strain gage: θ₁, θ₂ taper angle.

1. A cylindrical member, wherein
the cylindrical member is formed of a fiber reinforced plastic having a relationship expressed by Formula 2 when a stress-strain relational equation in an XY-plane is expressed as shown by Formula 1 in an orthogonal coordinate system O-XYZ, in which an origin O is a midpoint in a thickness direction, of a small-sized element of the cylindrical member, an X-axis is along a tangent direction of a cylinder, a Y-axis is along a direction parallel to an axial direction of the cylinder, a Z-axis is along a radial direction of the cylinder, σ is a stress vector, ε is a strain vector, τ is shear stress, γ is shear strain, and an element Qᵢⱼ is an i-th row, j-th column element of an in-plane rigidity matrix Q.
$$Formula 1$$
$$\{ \begin{matrix}{σ}_{x} \\ {σ}_{y} \\ {τ}_{xy}\end{matrix} \} ≡ \{ σ \} = [ \begin{matrix}{Q}_{11} & {Q}_{12} & {Q}_{16} \\ {Q}_{12} & {Q}_{22} & {Q}_{26} \\ {Q}_{16} & {Q}_{26} & {Q}_{66}\end{matrix} ] \{ \begin{matrix}{ε}_{x} \\ {ε}_{y} \\ {γ}_{xy}\end{matrix} \} ≡ [ Q ] \{ ε \}$$
$$Formula 2$$
$${Q}_{12} {Q}_{26} - {Q}_{16} {Q}_{22} \neq 0$$

2. The cylindrical member according to claim 1, wherein
the element Qᵢⱼ satisfies a relationship expressed by a following formula.
$$Formula 3$$
$$\frac{1}{\vert det Q \vert} \vert {Q}_{12} {Q}_{26} - {Q}_{16} {Q}_{22} \vert \geq 0.002 ( 1 / GPa )$$

3. The cylindrical member according to claim 1, wherein
the element Qᵢⱼ satisfies a relationship expressed by a following formula.
$$Formula 4$$
$$\frac{1}{\vert det Q \vert} \vert {Q}_{12} {Q}_{26} - {Q}_{16} {Q}_{22} \vert \geq 0.005 ( 1 / GPa )$$

4. The cylindrical member according to claim 1, wherein
the element Qᵢⱼ satisfies a relationship expressed by a following formula.
$$Formula 5$$
$$\frac{1}{\vert det Q \vert} \vert {Q}_{12} {Q}_{26} - {Q}_{16} {Q}_{22} \vert \geq 0.01 ( 1 / GPa )$$

5. The cylindrical member according to claim 1, wherein
the fiber reinforced plastic includes a plurality of fiber reinforced plastic layers, in which part or all of fibers are formed of continuous fibers, and
the fiber reinforced plastic is formed to satisfy a relationship expressed by Formula 10, in which the element Aᵢⱼ is expressed as shown by Formula 7, wherein N represents a resultant force vector of the fiber reinforced plastic layers, the element Aᵢⱼ is an i-th row, j-th column element of an equivalent in-plane rigidity matrix A calculated according to classical lamination theory, and a resultant force-strain relational equation in the XY-plane is expressed as shown by Formula 6, and in which the element Qᵢⱼ(bar) shown in Formula 7 is expressed as shown by Formulae 8 and 9, wherein an L direction is a fiber direction of each of the fiber reinforced plastic layers, a T direction is a direction perpendicular to the L direction, and the L direction is expressed by a rotation angle θ counterclockwise from the X-axis.
$$Formula 6$$
$$\{ N \} = \{ \begin{matrix}{N}_{x} \\ {N}_{y} \\ {N}_{xy}\end{matrix} \} = [ A ] \{ ε \} = [ \begin{matrix}{A}_{11} & {A}_{12} & {A}_{16} \\ {A}_{12} & {A}_{22} & {A}_{26} \\ {A}_{16} & {A}_{26} & {A}_{66}\end{matrix} ] \{ \begin{matrix}{ε}_{x} \\ {ε}_{y} \\ {γ}_{xy}\end{matrix} \}$$
$$Formula 7$$
$${A}_{ij} = {\sum }_{k = 1}^{N} {( {\overline{Q}}_{ij} )}_{k} ( {z}_{k} - {z}_{k - 1} )$$
$$( i , j = 1 , 2 , 6 )$$
where, in Formula 7, the element Qᵢⱼ(bar) is a stress-strain relational equation in a k-th layer of the fiber reinforced plastic layers, and zₖ is a Z coordinate at a radial boundary of the k-th layer.
$$Formula 8$$
$${\overline{Q}}_{11} = {c}^{4} {Q}_{11} + {s}^{4} {Q}_{22} + 2 ( {Q}_{12} + 2 {Q}_{66} ) {c}^{2} {s}^{2}$$
$${\overline{Q}}_{22} = {s}^{4} {Q}_{11} + {c}^{4} {Q}_{22} + 2 ( {Q}_{12} + 2 {Q}_{66} ) {c}^{2} {s}^{2}$$
$${\overline{Q}}_{12} = ( {c}^{4} + {s}^{4} ) {Q}_{12} + ( {Q}_{11} + {Q}_{22} - 4 {Q}_{66} ) {c}^{2} {s}^{2}$$
$${\overline{Q}}_{66} = ( {c}^{4} + {s}^{4} ) {Q}_{66} + ( {Q}_{11} + {Q}_{22} - 2 {Q}_{12} - 2 {Q}_{66} ) {c}^{2} {s}^{2}$$
$${\overline{Q}}_{16} = ( {Q}_{11} - {Q}_{12} - 2 {Q}_{66} ) {c}^{3} s + ( {Q}_{12} - {Q}_{22} + 2 {Q}_{66} ) {cs}^{3}$$
$${\overline{Q}}_{26} = ( {Q}_{11} - {Q}_{12} - 2 {Q}_{66} ) {cs}^{3} + ( {Q}_{12} - {Q}_{22} + 2 {Q}_{66} ) {c}^{3} s$$
where c=cos θₖ and s=sin θₖ
$$Formula 9$$
$${Q}_{11} = {mE}_{L}$$
$${Q}_{22} = {mE}_{T}$$
$${Q}_{12} = {mv}_{LT} {E}_{T}$$
$${Q}_{66} = m {G}_{LT}$$
$$m = 1 / ( 1 - {v}_{LT}^{2} {E}_{T} / {E}_{L} )$$
where, in Formula 9, E_{L} is a tensile modulus of elasticity in the L direction of the k-th layer, E_{T} is a tensile modulus of elasticity in the T direction of the k-th layer, ν_{LT} is a Poisson ratio in an LT direction of the k-th layer, and G_{LT} is a shear modulus of elasticity in the LT direction.
$$Formula 10$$
$${A}_{12} {A}_{26} - {A}_{16} {A}_{22} \neq 0$$

6. The cylindrical member according to claim 5, wherein
the element Aᵢⱼ satisfies a relationship expressed by a following formula, wherein t represents a plate thickness of the cylinder.
$$Formula 11$$
$$\frac{t}{\vert det A \vert} \vert {A}_{12} {A}_{26} - {A}_{16} {A}_{22} \vert \geq 0.002 ( 1 / GPa )$$

7. The cylindrical member according to claim 5, wherein
the element Aᵢⱼ satisfies a relationship expressed by a following formula, wherein t represents a plate thickness of the cylinder.
$$Formula 12$$
$$\frac{t}{\vert det A \vert} \vert {A}_{12} {A}_{26} - {A}_{16} {A}_{22} \vert \geq 0.005 ( 1 / GPa )$$

8. The cylindrical member according to claim 5, wherein
the element Aᵢⱼ satisfies a relationship expressed by a following formula, wherein t represents a plate thickness of the cylinder.
$$Formula 13$$
$$\frac{t}{\vert det A \vert} \vert {A}_{12} {A}_{26} - {A}_{16} {A}_{22} \vert \geq 0.01 ( 1 / GPa )$$

9. The cylindrical member according to claim 5, wherein
part of the fibers of the fiber reinforced plastic have a tensile modulus of elasticity in the fiber direction greater than or equal to 300 gigapascal (GPa).

10. The cylindrical member according to claim 9, wherein
part of the fibers of the fiber reinforced plastic are carbon fiber.

11. A tapered part-attached cylindrical member comprising:
a straight body part including the cylindrical member according to claim 1; and
a tapered part having a cylindrical shape, the tapered part being connected to one end side in a cylindrical axial direction of the straight body part, and having an inner diameter expanding along the cylindrical axial direction from one end side where connection to the straight body part is made.

12. The tapered part-attached cylindrical member according to claim 11, wherein
the tapered part has a plurality of taper angles that gradually increase along the cylindrical axial direction, starting from the one end side where connection to the straight body part is made.

13. The tapered part-attached cylindrical member according to claim 11, wherein
at least one of the straight body part or the tapered part has a portion where a doubler for reinforcement is provided to increase plate thickness.

14. The tapered part-attached cylindrical member according to claim 13, wherein
the tapered part has a portion whose plate thickness changes continuously along the cylindrical axial direction.

15. A surface magnet motor comprising:
the cylindrical member according to claim 1; and
a rotor core unit press fit into an inner diameter side of the cylindrical member.

16. A method for producing the surface magnet motor according to claim 15, the method comprising:
exerting a torsional moment on the cylindrical member;
press fitting the rotor core unit into the inner diameter side of the cylindrical member with the torsional moment being kept exerted on the cylindrical member; and
removing the torsional moment exerted on the cylindrical member after the rotor core unit is press fit into the inner diameter side of the cylindrical member.

17. The method for producing the surface magnet motor, according to claim 16, wherein
a plurality of ones of the rotor core unit are press fit into the inner diameter side of the cylindrical member, and
the method further comprises cutting the cylindrical member according to a length of each of the rotor core units after removal of the torsional moment exerted on the cylindrical member.

18. A method for producing a surface magnet motor, using the tapered part-attached cylindrical member according to claim 11, the method comprising:
fixing a twisting jig on each of the straight body part and the tapered part;
exerting a torsional moment on the twisting jig to cause the torsional moment to be transferred to the tapered part-attached cylindrical member;
inserting the rotor core unit from a side on which the tapered part is present, and press fitting the rotor core unit into an inner diameter side of the straight body part with the torsional moment being kept exerted on the tapered part-attached cylindrical member; and
removing the torsional moment exerted on the tapered part-attached cylindrical member after the rotor core unit is press fit into the inner diameter side of the straight body part.

19. The method for producing a surface magnet motor, according to claim 18, wherein
a plurality of ones of the rotor core unit are press fit into the inner diameter side of the straight body part, and
the method further comprises cutting the straight body part according to a length of each of the rotor core units after removal of the torsional moment exerted on the tapered part-attached cylindrical member.
